(19) United States
(12) Patent Application Publication
(10) Pub. No.: US 2006/0068136 A1
(43) Pub. Date: Mar. 30, 2006

(54) Method for molding a molded product and housing for electronic apparatus

(76) Inventors: Kazuyuki Kinjou, Tokyo (JP); Hiroaki Hirao, Tokyo (JP); Masaaki Takada, Tokyo (JP)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 11/208,290

(22) Filed: Aug. 19, 2005

(30) Foreign Application Priority Data
Sep. 28, 2004 (JP) P2004-282101

(51) Int. Cl. B29C 45/00; B31B 45/00

(52) U.S. Cl. 428/34.1; 264/328.1

(57) ABSTRACT

A method for molding a molded product including a case having a basic thickness and a rib section integrally projecting from the case and a projection height of which is large relative to the basic thickness, including: forming an injection-molding cavity being in communication with a case-molding cavity and a rib-section-molding cavity by closing a first mold and a second mold; locating a projecting strip, which is formed on an inner surface of the first mold and having an inclined face for guiding a flow of a molten resin material in a direction of the rib-section-molding cavity, at a position opposing the rib-section-molding cavity; injecting the molten resin or the molten metal material into the injection-molding cavity, to thus fill the injection-molding cavity therewith; and opening the first mold and the second mold, thereby retrieving a molded product from the injection-molding cavity.

### CROSS-REFERENCE TO RELATED APPLICATIONS

This application is based upon and claims the benefit of priority from the prior Japanese Patent Application No. 2004-282101, filed on Sep. 28, 2004; the entire contents of which are incorporated herein by reference.

### BACKGROUND

1. Field

Embodiments of the invention relate to a method for molding an injection-molded product; and to a housing for an electronic apparatus obtained in accordance with the molding method.

2. Description of the Related Art

Conventionally, as shown in FIGS. 6 and 7, a housing 1 constituting an external portion of a notebook computer includes a bottom wall 2 constituting a case having a basic thickness “t” (e.g., t=1.8 mm); and a rib wall 3 which integrally projects from an inner surface of the bottom wall 2 and which constitutes a rib section of a large projection height H, which is large relative to the basic thickness “t.” The housing 1 is injection-molded from a resin material, such as a mixture of a polycarbonate resin and an ABS resin, or a metal material, such as magnesium.

FIG. 8 shows a related-art injection-molding machine 10 for forming the housing 1 from a resin material of a mixture of a polycarbonate resin and an ABS resin. The injection-molding machine 10 includes a mold assembly 16, a hydraulic cylinder 17, and an injection unit 18. Inside the mold assembly 16, a first mold 11 and a second mold 12 close, thereby forming an injection-molding cavity 15 which is in communication with a bottom-wall-molding cavity 13 and a rib-wall-molding cavity 14. The hydraulic cylinder 17 opens and closes the mold assembly 16. The injection unit 18 injects a molten resin in a state in which the mold assembly 16 is heated to a predetermined mold temperature, thereby filling the injection-molding cavity 15 with the molten resin.

The housing 1 is integrally formed through a step of injecting a molten resin into the injection-molding cavity 15 in a state in which the mold assembly 16 is heated to the predetermined mold temperature, to thus effect injection and filling; and a step of, subsequent to solidification of the injected resin, opening the mold assembly 16, to thus retrieve a molded product from the injection-molding cavity 15 (see, e.g., JP-A-2001-18048).

### BRIEF DESCRIPTION OF THE DRAWINGS

The accompanying drawings, which are incorporated in and constitute a part of the specification, illustrate presently preferred embodiments of the invention, and together with the general description given above and the detailed description of the preferred embodiments given below, serve to explain the principles of the invention.

FIG. 1 is an exemplary cross-sectional configuration view showing an injection-molding machine for performing a molding method according to an embodiment of the invention;

FIG. 2 is an exemplary enlarged cross-sectional view of an essential portion of a mold assembly in the injection-molding machine;

FIG. 3 is an exemplary explanatory view of operations in a state in which a molten resin is injected in a cavity of the mold assembly;

FIG. 4 is an exemplary enlarged cross-sectional view of an essential portion of another example of the mold assembly;

FIG. 5 is an exemplary enlarged cross-sectional view of an essential portion of another example of the mold assembly;

FIG. 6 is an exemplary perspective view of an essential portion of a housing of an electronic apparatus, as viewed from an external face side;

FIG. 7 is an exemplary perspective view of an essential portion of the housing, as viewed from an inner face side;

FIG. 8 is a cross-sectional configuration view showing a related-art injection-molding machine; and

FIG. 9 is an explanatory view sequentially showing a resin flow for a case where a housing is molded from a resin with use of the related-art injection-molding machine.

### DETAILED DESCRIPTION

Hereinbelow, embodiments of the present invention will be described with reference to the accompanying drawings.

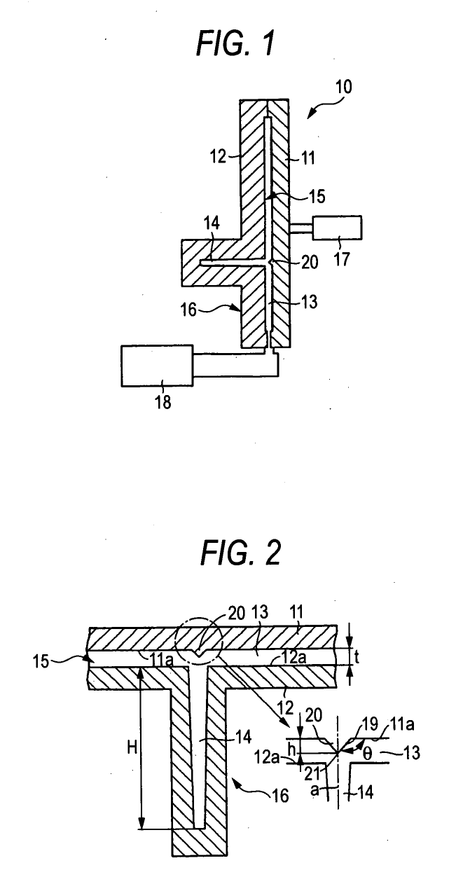

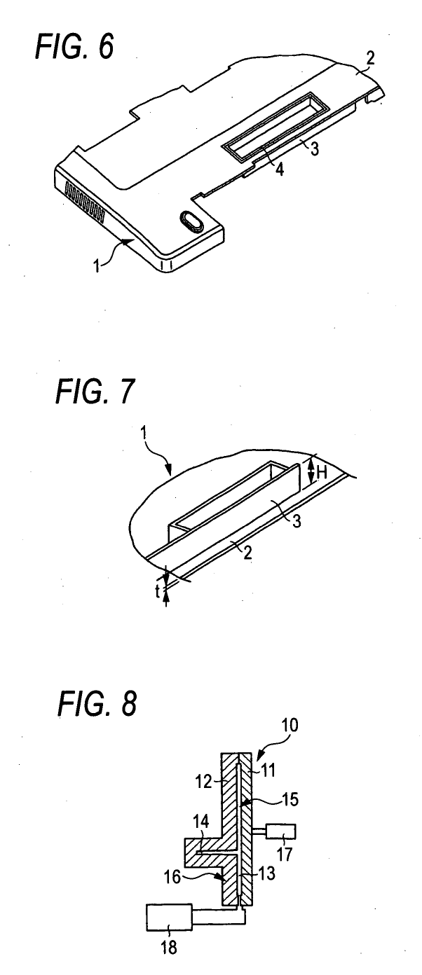

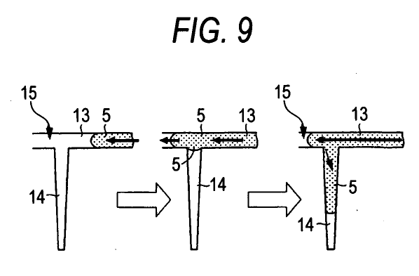

A method for molding a molded product of the invention is a method for molding a housing 1 including, as shown in FIGS. 6 and 7, a bottom wall 2 serving as a case having a basic thickness “t” (for instance, t=1.8 mm); and a rib wall 3 which integrally projects from an inner face of the bottom wall 2 and which constitutes a rib section of an extremely large projection height; e.g., H=18 mm, which is large relative to the basic thickness “t.” In FIG. 1, where portions corresponding those shown in FIG. 8 are denoted by identical reference numerals, reference numeral 10 denotes an injection-molding machine employed in a case where the housing 1 is molded from a resin material of a mixture of a polycarbonate resin and an ABS resin.

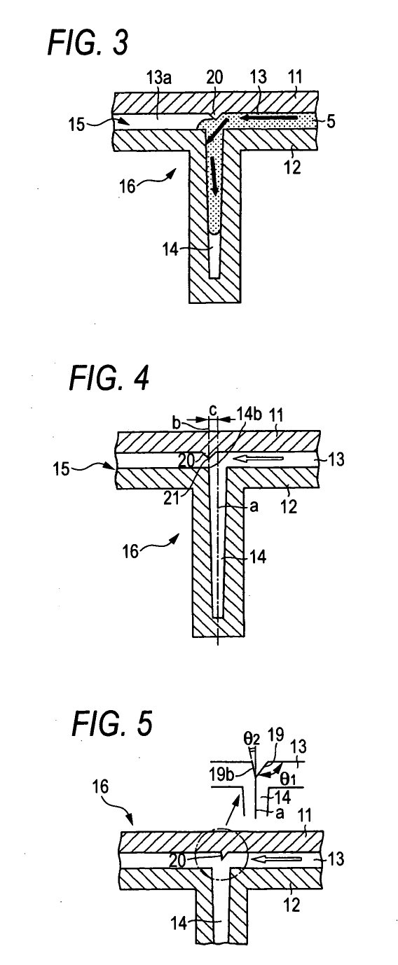

The injection-molding machine 10 includes a mold assembly 16, a hydraulic cylinder 17, and an injection unit 18. Inside the mold assembly 16, a first mold 11 and a second mold 12 close, thereby forming an injection-molding cavity 15 which is in communication with a bottom-wall-molding cavity 13 and a rib-wall-molding cavity 14. The hydraulic cylinder 17 opens and closes the mold assembly 16. The injection unit 18 injects a molten resin 5 (shown in FIG. 3) into the injection-molding cavity 15 in a state in which the mold assembly 16 has been heated to a predetermined mold temperature; e.g., about 200° C., thereby filling the injection-molding cavity 15 with the molten resin 5.

A space height H (see FIG. 2) of the rib-wall-molding cavity 14 in the mold assembly 16 is set to a value corresponding to a projection height H of the rib wall 3 (a height of 180 mm corresponding to ten times a space height “t” of the bottom-wall-molding cavity 13).

On an inner surface of either the first mold 11 or the second mold 12 (in this embodiment, the first mold 11 that does not have the rib-wall-molding cavity 14), at a position opposing the rib-wall-molding cavity 14, there is disposed a projecting strip 20 of a predetermined height “h” as shown in FIG. 2. The projecting strip 20 has an inclined face 19 for guiding a flow of the molten resin 5 injected into the bottom-wall-molding cavity 13 in a direction of the rib-wall-molding cavity 14 as shown by an arrow in FIG. 3.

The projecting strip 20 is formed so as to have a triangular cross-sectional profile which is laterally-symmetric with respect to an axis “a” passing through a center of the rib-wall-molding cavity 14; a height “h” of a triangle apex 21 as measured from an inner-mold surface 11a is set to one-third or less the space height “t” of the bottom-wall-molding cavity 13 (for instance, set to 0.6 mm); and each of the inclined faces 19 of the triangular projecting-strip 20 is formed with an oblique inclination angle θ which allows guiding of a flow of the molten resin 5 injected into the bottom-wall-molding cavity 13 in a direction of the rib-wall-molding cavity 14 as shown by the arrow in FIG. 3.

More specifically, in practice, an inclination angle θ of the inclined face 19 located on a side of the projecting strip 20 from which the molten resin is fed is preferably set to about 120 to 130° with respect to an inner-mold surface 11a of the first mold 11.

The reason for setting the height “h” of the projecting strip 20 as measured from the inner-mold surface 11a to one-third or less the space height “t” of the bottom-wall-molding cavity 13 is for ensuring a smooth resin flow in a direction of a remaining space section 13a (shown in FIG. 3) of the bottom-wall-molding cavity 13 by means of forming, between the triangle apex 21 and an inner-mold surface 12a of the bottom-wall-molding cavity 12, a resin-flowing space whose height is two-thirds or more the space height “t” of the bottom-wall-molding cavity 13.

When, as shown in FIG. 2, the projecting strip 20 of the triangular cross-sectional profile as described above is disposed on the inner face of the first mold 11, at a position opposing the rib-wall-molding cavity 14, the flow of the molten resin 5 injected to the bottom-wall-molding cavity 13 is guided in the direction of the rib-wall-molding cavity 14 as shown by the arrow in FIG. 3, thereby filling the rib-wall-molding cavity 14 with the molten resin 5; and subsequent to this filling, the molten resin 5 is injected and filled into the remaining space 13a of the bottom-wall-molding cavity 13. Hence, since the projecting strip 20 functions as a guide for the resin flow, there can be prevented a problem of short shot which may be otherwise occur when a large-height rib shape is molded.

In addition, the projecting strip 20 has a triangular cross-sectional profile which is laterally-symmetric with respect to the axis “a” passing through the center of the rib-wall-molding cavity 14. Accordingly, even when an resin-injection direction into the bottom-wall-molding cavity 13 is changed to a direction from a distal end of the cavity 13 (this change results from directional-switching of a resin-injection gate of the mold assembly 16), a flow of a molten resin injected from the terminal end of the cavity 13 can be guided in the direction of the rib-wall-molding cavity 14, thereby filling the rib-wall-molding cavity 14 with the resin, as well as facilitating release of a molded product at a time of mold opening of the mold assembly 16.

Meanwhile, the projecting strip 20 can be disposed while being displaced so that the apex 21 thereof is located between the axis “a” passing through the center of the rib-wall-molding cavity 14 and an axis “b” which is parallel to the axis “a” and which passes through an open edge section 14b at a downstream end in a flow-in direction of the molten resin of the rib-wall-molding cavity 14 (that is, within a range indicated by reference numeral “c” in FIG. 4). Even when the projecting strip 20 is disposed at such a displaced position, there can be yielded the same effects as those of the embodiment shown in FIGS. 2 and 3.

FIG. 5 shows another example in which a shape of the projecting strip 20 is changed.

In this example, the projecting strip 20 is formed so as to have a cross-sectional profile of a triangle which is laterally-asymmetric with respect to the axis “a” passing through the center of the rib-wall-molding cavity 14; the inclined face 19 located on an upstream side of the flow-in direction of the molten resin is formed with an oblique inclination angle θ1 (an angle of about 120 to 130° with respect to the inner-mold surface) which allows guiding of a flow of the molten resin injected into the bottom-wall-molding cavity 13 in a direction of the rib-wall-molding cavity 14; and a projecting strip face 19b is formed on the side opposite the inclined face 19 so as to have a small mold-draft angle of θ2 (about 3 to 5°) Even when such a laterally-asymmetric projecting strip 20 is disposed, there can be yielded the same effects as those of the mode shown in FIGS. 2 and 3.

A molded product obtained by the molding method of the example is the housing 1 for an electronic apparatus. As shown in FIGS. 6 and 7, the housing 1 includes the bottom wall 2 constituting a case of the basic thickness “t”; the rib wall 3 which integrally projects from an inner surface of the bottom wall 2 and which constitutes a rib section of an extremely-large projection height H, which is large relative to the basic thickness “t”; and a groove 4 formed in the external surface of the bottom wall 2 and at a position opposing the rib-wall as a shape which is formed as a result of release from the projecting strip 20 of the mold. In this case, the groove 4 can yield a function as a concavity for improving an exterior appearance of the product, to thus enhance appearance of the housing 1. This groove 4, however, may be concealed when the housing 1 is coated or painted.

The embodiments have been described a case where the housing 1 serving as a molded product is molded from a synthetic resin. However, the invention is not limited thereto, and may be applied to a method for molding a housing from a metal material, such as magnesium. In addition, the molded product is not limited to the above-described housing 1, and may be applied to a main body of any of a variety of electronic apparatuses, such as a television, so long as the apparatus has a case of a basic thickness, and a rib section which integrally projects from the case and which is of an extremely-large projection height in relation to the basic thickness.

Meanwhile, the invention is not limited to the embodiments, and when being practiced, the invention can be modified in various manners without departing from the scope of the invention. In addition, a variety of inventions can also be realized by appropriately combining the plurality of constituent elements disclosed in the embodiment. For example, some elements may be omitted from the elements described in embodiments. Moreover, elements used in different embodiments may be combined.

What is claimed is:

1. A method for molding a molded product including a case having a basic thickness, and a rib section which integrally projects from the case and which has a large projection height that is large relative to the basic thickness, comprising:
forming an injection-molding cavity being in communication with a case-molding cavity and a rib-section-molding cavity by closing a first mold and a second mold;
locating a projecting strip, which is formed on an inner surface of the first mold and having an inclined face for guiding a flow of a molten resin or a flow of a molten metal material in a direction of the rib-section-molding cavity, at a position opposing the rib-section-molding cavity;
injecting the molten resin or the molten metal material into the injection-molding cavity, to thus fill the injection-molding cavity therewith; and
subsequent to solidification of the injected resin or the injected molten metal, opening the first mold and the second mold, thereby retrieving a molded product from the injection-molding cavity.

2. The method for molding a molded product according to claim 1, wherein during forming the injection-molding cavity, setting a space height of the rib-section-molding cavity to a height exceeding eight times a space height of the case-molding cavity.

3. The method for molding a molded product according to claim 1, wherein the projecting strip is formed so as to have a triangular cross-sectional profile which is laterally-symmetric with respect to an axis passing through a center of the rib-section-molding cavity;
a height of a triangle apex as measured from the inner surface of the first mold is set to one-third or less a space height of the case-molding cavity; and
each of inclined faces of the triangular projecting strip is formed with an oblique inclination angle which allows guiding of a flow of the molten resin or of the molten metal injected into the case-molding cavity in a direction of the rib-section-molding cavity.

4. The method for molding a molded product according to claim 1, wherein the projecting strip is formed so as to have a triangular cross-sectional profile which is laterally-asymmetric with respect to an axis passing through a center of the rib-section-molding cavity; and
an inclined face of the projecting strip located on a side from which the molten resin or the molten metal is fed is formed with an oblique inclination angle which allows guiding of a flow of the molten resin or of the molten metal injected into the case-molding cavity in a direction of the rib-section-molding cavity.

5. The method for molding a molded product according to claim 3, wherein the inclined face of the projecting strip located on a side from which the molten resin or the molten metal is fed is formed with an oblique inclination angle of about 120 to 130° with respect to the inner face of the first mold.

6. The method for molding a molded product according to claim 4, wherein the inclined face of the projecting strip located on a side from which the molten resin or the molten metal is fed is formed with an oblique inclination angle of about 120 to 130° with respect to the inner face of the first mold.

7. The method for molding a molded product according to claim 1, wherein the projecting strip is disposed while being displaced so that an apex of the projecting strip is located between a first axis passing through a center of the rib-section-molding cavity and a second axis parallel to the first axis and passing through an open edge section at a downstream end in a flow-in direction of the molten resin or of the molten metal of the rib-section-molding cavity.

8. A housing for an electronic apparatus, comprising:
a wall constituting a case of a basic thickness;
a rib wall which integrally projects from an inner surface of the wall and which constitutes a rib section of an extremely large projection height that is large relative to the basic thickness; and
a groove formed in an external surface of the wall and at a position opposing the rib wall, as a shape which is created as a result of release from a projecting strip that is formed on a mold.

9. The housing for an electronic apparatus according to claim 8, wherein the housing is formed from a synthetic resin, and the rib wall is formed as an extremely large projection height exceeding eight times the basic thickness of the wall.
